(19) United States
(12) Patent Application Publication
(10) Pub. No.: US 2016/0229001 A1
(43) Pub. Date: Aug. 11, 2016

(54) THERMAL-MANAGEMENT SYSTEMS FOR CONTROLLING TEMPERATURE OF WORKPIECES BEING JOINED BY WELDING

(71) Applicant: GM Global Technology Operations LLC, Detroit, MI (US)

(72) Inventors: Teresa J. Rinker, Royal Oak, MI (US); Debejyo Chakraborty, Novi, MI (US); Ryan C. Sekol, Grosse Pointe Woods, MI (US); Jeffrey A. Abell, Rochester Hills, MI (US)

(21) Appl. No.: 15/017,067

(22) Filed: Feb. 5, 2016

Related U.S. Application Data
(60) Provisional application No. 62/112,620, filed on Feb. 5, 2015.

(51) Int. Cl. B23K 37/00; B23K 9/235

(52) U.S. Cl. CPC B23K 37/003; B23K 9/235; B23K 37/00

(57) ABSTRACT

A thermal-management system, for use in controlling temperature of at least a first workpiece of multiple workpieces being joint. The thermal-management system includes a thermal sleeve sized and shaped to at least partially surround the first workpiece during operation of the thermal-management system. The thermal sleeve comprises a fluid compartment configured to hold heat-transfer fluid, such as nanofluid, for use in heating or cooling the first workpiece during operation of the thermal-management system. In various embodiments, the thermal-management system includes a fixture portion having an elongate channel for affecting temperature by way of heat-transfer fluid passed through the channel. In some embodiments, the thermal-management system includes a heat-transfer fluid bath body for holding heat-transfer fluid to cool or heat workpieces being welded together.

### TECHNICAL FIELD

The present disclosure relates generally to systems for controlling temperature of workpieces being joined, and more particularly to heat-exchange systems, such as micro heat exchangers, using a heat-transfer fluid such as a nanofluid to control temperature of workpieces being joined by welding.

### BACKGROUND

Welding is a common way to join similar and dissimilar materials in a wide range of industries, including consumer electronics, home products and appliances, farming, construction equipment, transportation systems, and the like.

The dissimilar materials can include dissimilar metals, dissimilar polymers, or combinations of polymers and metals. The manufacturer can select favorable characteristics, such as being lightweight, highly-conformable or shapeable, strong, durable, or having a desired texture or color by combining some polymer or composite materials with other materials. An article of manufacture may include various components (exterior, interior, or decorative features) where materials are selected and configured to withstand a hot and/or chemically aggressive environment or for painting or chemical resistance over time.

With the increased use of polymers and other low-mass materials, compression molding and post-mold joining techniques, such as laser welding and ultrasonic welding, are also being used more commonly. Some workpieces, including polymer composites, have relatively low melting points, and some workpieces, including metals, have relatively high conductivity. Whether welding one or both types of workpiece, it is difficult and in many cases impossible to join the workpieces at a target interface accurately, quickly, and with minimal melting of other portions of the workpieces.

In addition, some conventional approaches require undesirably high welding cycle times, including time to make the weld. Conventional welding techniques also lack means to rapidly heat workpieces being joined or cool workpieces recently joined, or at least a joined interface—that is, by a significant degree of temperature in a short amount of time. Moreover, conventional welding equipment, itself, would benefit from an improved heating and/or cooling system, configured and arranged to heat or cool at least one component of the equipment becoming heated during operation.

### SUMMARY

The present technology relates to systems and methods for controlling temperature of workpieces being joined by welding. Selective cooling and/or heating of the workpieces is effected using a heat exchanger, such as a micro heat exchanger, using a temperature-controlled nanofluid or other suitable fluid.

While nanofluids are discussed herein as the primary fluid for use in the present systems, other fluids having characteristics for performing as required can be used. The fluids can include, for instance, known coolants or refrigerants, or microfluids. The term microfluid can refer generally to fluids having micro-sized particles mixed or suspended in a base fluid, or simply fluids capable of effective movement through micro channels, such as those of the micro heat exchangers of the present technology.

In one embodiment, at least one of the workpieces is heated by relatively warm or hot fluid positioned in a fixture contacting the workpiece(s) directly or positioned adjacent the workpiece(s). The fixture can include a channel, chamber, or other compartment holding the heating fluid.

For embodiments in which the fluid channeling, or pathways are small, the arrangement can be referred to as a micro-heat exchanger.

In some heating implementations, the workpiece is heated by thermal energy flowing from the heated fluid to the fixture, such as by conduction, and thermal energy passing in turn from the fixture heated to the workpiece, also by conduction and/or any of convection, radiation, or any combination of these depending on the arrangement.

Heating one or both of the two workpieces being joined has benefits including facilitating increased internal energy or melting of the workpieces, and any implements (e.g., one or more energy directors), at and/or adjacent a welding interface in the welding process. One or both workpieces can be pre-heated, for example, thereby reducing the amount of temperature rise that needs to be effected by the welding head—e.g., laser head or ultrasonic welding head—for bonding the material forming a connecting weld joint. For instance, one of the workpieces can be heated directly by the heat exchanger, such as by direct contact with the exchanger, while the other is heated indirectly, such as by the exchanger or by way of the other workpiece, the two workpieces being in contact.

In one embodiment, at least one of the workpieces is cooled by relatively cool or cold fluid. The application may include, for example, nanofluid positioned in a fixture that contacts the workpiece(s) directly or is positioned adjacent to the workpiece(s). Again, the fixture can include channels or other compartments holding the fluid, in this case a cooling fluid.

The workpiece is cooled by thermal, or kinetic, energy flowing from the workpiece to the fixture by conduction, convention, radiation, or any combination of these depending on the arrangement.

Cooling one or both of the two workpieces joined has benefits including avoiding damage to the workpiece(s) from becoming overheated, or heated too long. Cooling workpieces can also expedite manufacturing, such as by allowing moving of the workpieces more quickly to a subsequent stage of the manufacturing process and by allowing sooner working of the workpieces at a next stage, whether at the same location in the manufacturing facility at which the welding takes place.

In some welding scenarios, depending for example on the material forming the weld joint, active, rapid cooling immediately after welding strengthens the joint being formed, resulting in a bond stronger than would be formed if the newly formed joint were allowed to cool slowly.

In implementations in which the workpieces include different metals, rapid cooling after welding reduces intermetallic compound formation or growth. With conventional techniques, intermetallic compounds commonly form while joining dissimilar metals, growing thicker as temperatures rises over time in the joining. Generally intermetallic compounds have low ductility, low conductivity, and thus degrade the quality of the joint.

In one implementation, a first portion of a workpiece is heated while a second portion is cooled by a relatively low-temperature nanofluid in another adjacent fixture component. The first portion is heated by, for example, a relatively high-temperature nanofluid in a fixture component positioned adjacent the workpiece, while the second portion is cooled by, for example, a relatively low-temperature nanofluid in another fixture component positioned adjacent the workpiece.

In one embodiment, at least one of the workpieces is cooled by relatively cool or cold fluid, such as a chilled nanofluid, contacting the workpiece(s) directly. The workpiece is cooled by thermal, or kinetic, energy flowing from the workpiece to the fixture by conduction, convention, or a combination of these depending on the arrangement.

In one embodiment, at least one of the workpieces is heated by relatively warm or hot fluid contacting the workpiece(s) directly.

In one implementation, a first portion of a workpiece is heated, by a first, relatively high-temperature nanofluid in contact with the workpiece, while a second portion of the same workpiece is cooled by a second, relatively low-temperature nanofluid, in contact, possibly with a micro-heat exchanger, with the second portion.

In a contemplated embodiment, a first portion of a workpiece is heated by heated nanofluid positioned in a fixture adjacent the first portion, while a second portion of the workpiece is cooled by chilled nanofluid contacting the second portion.

In another contemplated embodiment, a first portion of a workpiece is cooled by chilled nanofluid positioned in a fixture adjacent the first portion, while a second portion of the workpiece is heated by a heated nanofluid contacting the second portion.

In another aspect, the technology relates to cooling welding equipment using a relatively cold nanofluid positioned in (e.g., passing through) a compartment adjacent the equipment. A primary welding-equipment component to be cooled, or chilled, is a welding head. In operation of a fusion- or laser-type welding apparatus, for instance, a laser head heats while emitting laser rays for forming the weld. Without sufficient cooling, performance of the head could degrade and/or a life of the equipment or component could be limited.

In one embodiment, a wall of the compartment contacts a portion of the welding equipment (e.g., welding head) being cooled. In a contemplated embodiment, the compartment is configured and arranged (e.g., connected to the welding equipment) so that the cooling fluid directly contacts the welding equipment component(s)—e.g., welding head—being cooled.

The cooling component can be, include, or be a part of what can be referred to as a heat exchanger. For smaller-scale implementations, the cooling apparatus can be referred to as a micro-heat exchanger.

Other aspects of the present invention will be in part apparent and in part pointed out hereinafter.

### DESCRIPTION OF THE DRAWINGS

FIG. 1 illustrates a top view of a thermal-management system according to an embodiment of the present technology.

FIG. 2 illustrates a side view of the thermal-management system of FIG. 1.

FIG. 3 illustrates a side cross-sectional view of the thermal-management system of FIG. 1.

FIG. 4 illustrates a top view of a system according to another embodiment of the present technology.

FIGS. 5-10 illustrate perspective views of systems according to various other embodiments of the present technology.

FIGS. 11 and 12 illustrate side cross-sections of system according to other embodiments of the present technology, involving a fluid bath.

FIG. 13 illustrates an example controller, for instance, a computing architecture, according to an embodiment of the present technology.

The figures are not necessarily to scale and some features may be exaggerated or minimized, such as to show details of particular components. In some instances, well-known components, systems, materials or methods have not been described in detail in order to avoid obscuring the present disclosure.

Therefore, specific structural and functional details disclosed herein are not to be interpreted as limiting, but merely as a basis for the claims and as a representative basis for teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

While the present technology is described in connection with automobiles, primarily, the technology is not limited to automobiles. The concepts can be used in a wide variety of applications, such as in connection with aircraft, marine craft, and non-vehicle industries including consumer good and electronics, and others.

### I. GENERAL OVERVIEW OF THE DISCLOSURE

The present disclosure describes systems and methods for controlling temperature of (a) workpieces being joined by welding, (b) inter- or intra-welding structure (e.g., energy directors), and/or (c) welding equipment.

The thermal-management systems cool and/or heat the workpieces using a nanofluid, or other suitable fluid. While nanofluid is described primarily as the applicable fluid in embodiments herein, any embodiment described can be implemented by another suitable fluid, effective to achieve the stated purposes and goals, such as a fluid having micro-sized particles (or microfluid).

Exemplary types and engineering of nanofluids that can be used with the present technology are described further below, in the Nanofluids section (XVII.).

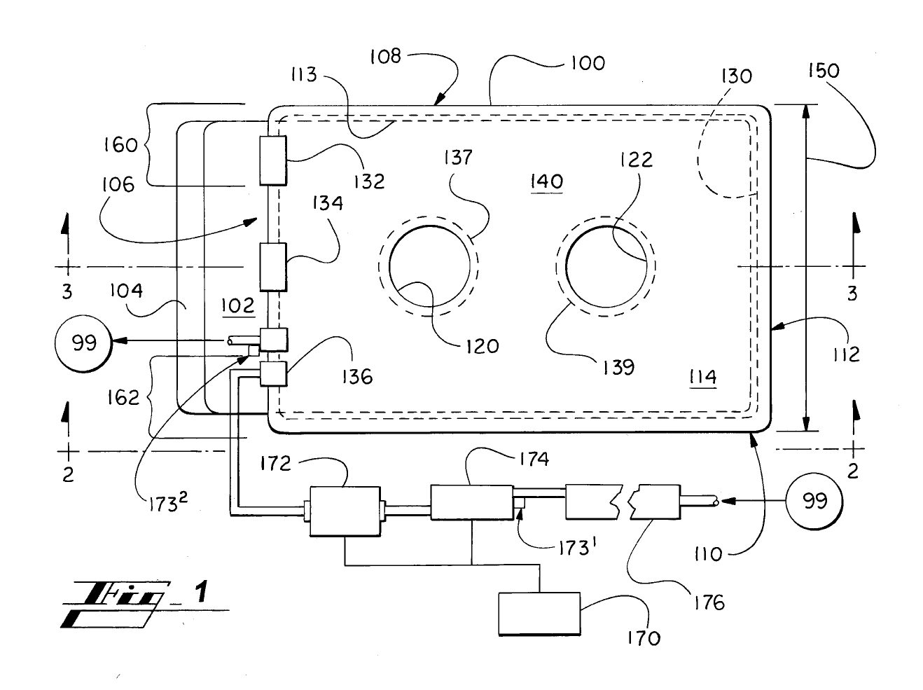

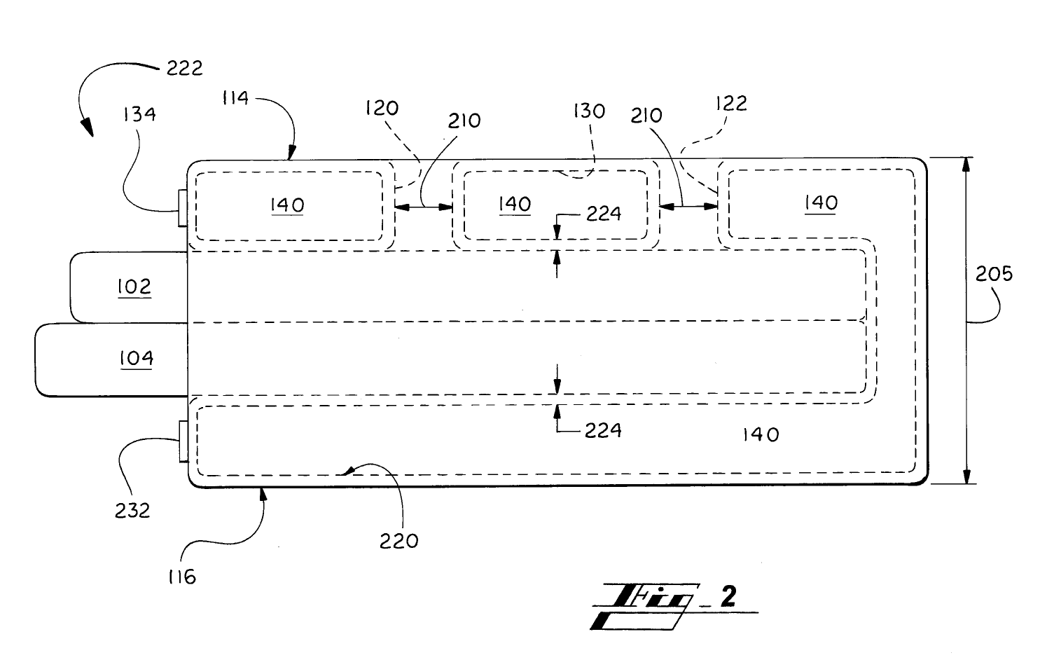

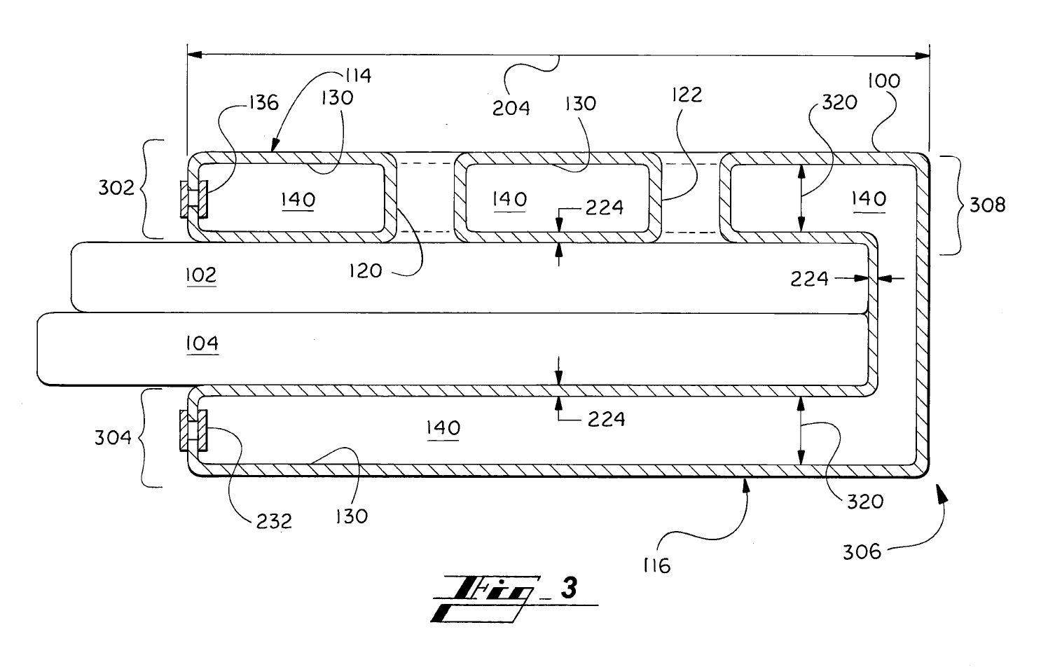

### II. FIG. 1, WITH REFERENCE TO FIGS. 2 AND 3

Now turning to the figures, and more particularly to the first figure, FIG. 1 shows a top, plan view of an example thermal-management system 100, or TMS. The thermal-management system 100, or portions thereof, can be referred to as a fixture, or can be joined to, or positioned on a traditional fixture, such as a welding table or anvil.

The thermal-management system 100 can also be referred to as a thermal-control system, a temperature-control system, a temperature-management system, or the like.

In various embodiments, the thermal-management system 100 controls or manages temperature of workpieces before, during, and/or after they are welded together.

As shown, simply by way of example, in FIGS. 1-3, the thermal-management system 100 can be configured (e.g., sized and shaped) and arranged to partially or completely envelop a first and a second workpiece, 102, 104. In these implementations, the thermal-management system 100 can also be referred to as a thermal-control sleeve, a thermal-control envelop, a temperature-control sleeve, a thermal-management sleeve, or the like.

References herein indicating direction are not made in a limiting manner. References to upper, lower, top, bottom, or lateral, for example, are not provided to limit the way in which the technology can be implemented. While an upper surface is referenced, for example, the referenced surface need not be vertically upward, or atop, in the operating reference frame, or above any other particular component, and can be aside or below some or all components instead. As further example, reference to the first workpiece 102 as an upper or top workpiece, and the second workpiece 104 as a lower or bottom workpiece, are not made to limit the orientation by which the thermal-management system 100 can be implemented. The directional references are provided herein mostly for ease of description and for simplified description of the example drawings.

The thermal-management system 100 includes an opening 106 sized and shaped to receive the workpieces 102, 104. The thermal-management system 100 further includes two opposing sides 108, 110, and an end 112 opposite the opening 106. Outlines of the workpieces 102, 104 within the thermal-control sleeve 100 are indicated by dashed lining 113.

In a contemplated embodiment (not shown in detail), the thermal-management system 100 is designed to close around the workpieces completely or substantially entirely, such as by including a hinged edge opposite an end at which the workpieces can be inserted and retrieved before and after the thermal management and welding.

The thermal-management system 100 also includes a first face 114 and a second face 116 (shown in FIGS. 2 and 3) opposite the first face. As mentioned above regarding the workpieces 102, 104, directional references herein to the system faces 114, 116, such as upper face or surface, do not limit the orientation by which the thermal-management system 100 can be implemented.

The thermal-management system 100 also includes two welding-access holes, or ports 120, 122. The ports 120, 122 allow welding together of the workpieces 102, 104 while the workpieces are positioned in the thermal-control system 100.

Although not shown, the thermal-management system 100 can include one or more openings or ports (not shown) on an opposite (e.g., bottom) side of the thermal-management system 100 than the weld-access ports 120, 122.

Such bottom-side ports can accommodate any opposing welding equipment or energy that needs to be applied to the workpieces from that side. The opposing equipment can include, for instance, a mating electrode, to work opposite and in conjunction with an electrode using the top-side ports 120, 122. As another example, the opposite-side equipment can include an implement to provide a force to the workpieces, such as a needed or otherwise advantageous upward, counter, or opposing force, such as to clamp, push, or maintain the workpieces in arrangement together, before, during, and/or after the welding.

The thermal-management system 100 further comprises at least one inner fluid channel, compartment, or chamber 130. The thermal-management system 100 further comprises at least two orifices 132, 134, 136. At least one of the orifices can be used for nanofluid input and another for output, or as a vent (e.g., air vent) facilitating input or output.

While the embodiments of FIGS. 1-4 include a fluid chamber, in some embodiments, the nanofluid is passed through pipes or tubes, as shown in FIGS. 5-9, for instance.

With continued reference to FIG. 1, dotted lines 137, 139 show the inner fluid chamber 130 extending to the welding access ports 120, 122.

For operation, the inner fluid chamber 130 is filled with nanofluid 140, such as heated nanofluid, or with chilled or cooled nanofluid.

In some implementations the chamber 130 is filled with hot nanofluid 140 at some point of operation of the thermal-management system 100 and filled with cold nanofluid 140 at another point of system operation.

The thermal-management system 100 in various embodiments comprises one or more interior structures (other than that shown in detail) for controlling direction and/or position of nanofluid 140 within the chamber 130. Example structures include baffles, dividers, walls, or the like. The chamber 130 can thus be divided into one or more separate or contiguous sub-chambers (not shown in FIGS. 1-3).

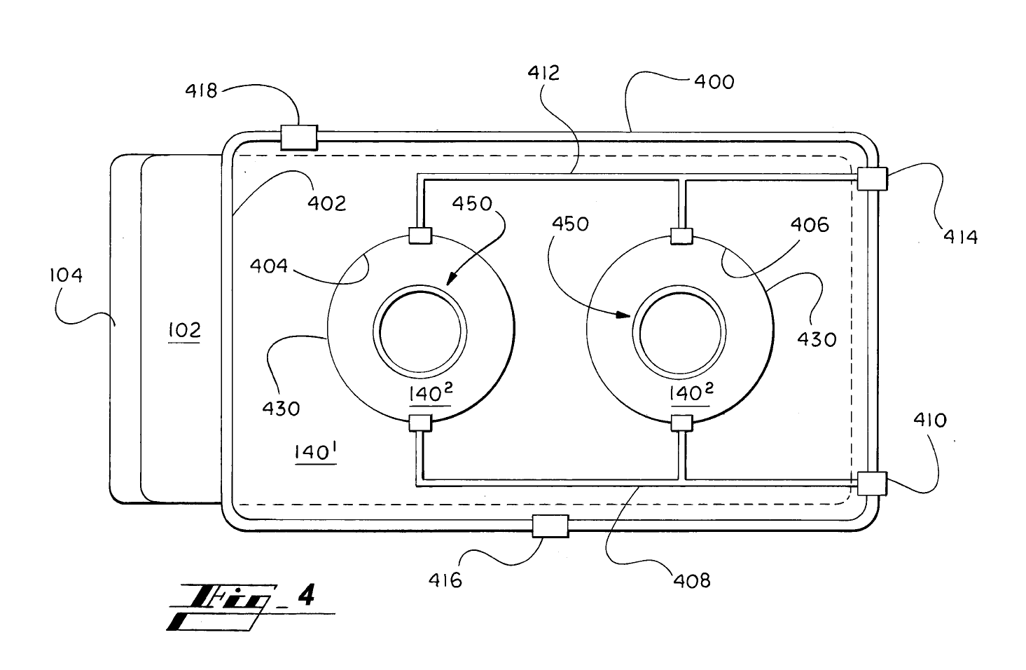

In some embodiments, the chamber includes at least two sub-chambers, whereby a first nanofluid 140 of a first temperature can be provided in the first sub-chamber, and a second nanofluid 140 of a second temperature provided in the second sub-chamber. FIG. 4 shows an example of such a design, and is described more below.

With further reference to FIG. 1, the inner fluid chamber 130 is filled with nanofluid 140, which can be warm or relatively hot to facilitate the welding process. The fluid 140 when hot or warm would by its proximate influence, raise temperature of one or both of the workpieces 102, 104, or at least a portion thereof. The arrangement can be used, as mentioned, for the benefit of preheating at least a portion of the workpieces 102, 104 at and/or adjacent a target welding area(s), to facilitate the welding process. Benefits can include expediting the process, and savings of energy used by the welding equipment.

For simplicity, the hot or warm nanofluid is referred to generally hereinafter as a ‘hot’ nanofluid, or ‘hot fluid’ to accommodate other types of suitable fluids, without limiting the temperature that the fluid can be made to have. Generally, the ‘hot’ nanofluid 140 has a temperature that is higher than a temperature of some or all of the workpieces 102, 104 so that the fluid tends to warm the workpieces 102, 104.

A relatively cold, or cool nanofluid can be used, as referenced above, to expedite cooling of the workpieces 102, 104 and/or of the welded area—i.e., weld interface, or joint. Cooling one or both of the workpieces 102, 104 joined has benefits including, as mentioned, avoiding damage to the workpiece(s) from becoming overheated or heated too long.

Cooling workpieces can also expedite manufacturing, such as by allowing moving of the workpieces more quickly to subsequent stages of the manufacturing process and/or allowing more quickly subsequent work on the workpieces even if at the same manufacturing station.

It has been found that in some welding scenarios, depending on the material forming the weld joint, for example, expedited, active, cooling immediately after welding strengthens the joint being formed. The resulting bond is stronger than would be formed if the newly formed joint were allowed to cool slowly.

As mentioned, advantages of cooling and, particularly, relatively rapid cooling, two dissimilar metals recently welded together includes inhibition of intermetallic compound formation, or growth.

Chilled, cold or cool nanofluid can be referred to as ‘cold nanofluid,’ or ‘cold fluid’ to accommodate embodiments using other suitable fluids.

Generally, the ‘hot’ nanofluid 140 has a temperature that is higher than a temperature of some or all of the workpieces 102, 104. The nanofluid 140 in these embodiments can thus be referred to as relatively hot, or relatively warm, being hot or warm with respect to a thermal context of some or all of the workpieces 102, 104 and/or of the environment—e.g., ambient air temperature in the manufacturing environment.

In some implementations, one or both of the workpieces 102, 104 are initially at an ambient manufacturing-environment temperature of between about 60 degrees Fahrenheit (F) and about 80 degrees F., when introduced to the thermal-control sleeve 100.

The nanofluid 140 can be heated or cooled to any temperature appropriate for the application. Considerations for determining a temperature or temperature range to heat to or cool to can include an amount and cost of energy required to obtain a target temperature, and the value of further heating or cooling—e.g., avoiding exceeding a temperature above or below which there will be small or diminishing relative returns. Consideration could also be given to avoiding damage or otherwise unwanted alteration to the thermal-management system and workpieces.

In some embodiments, the nanofluid 140 is heated to either (i) a pre-determined temperature, (ii) a temperature within a pre-determined range, or (iii) to a temperature that is above or below a pre-determined threshold temperature.

In some implementations, the nanofluid 140 is heated and controlled so as not exceed a maximum temperature, or not-to-exceed temperature. The nanofluid 140 control can include monitoring of the fluid temperature, such as by closed-loop feedback.

Likewise, in various implementations, the nanofluid 140 is cooled and controlled so as not to fall below a minimum temperature.

In some embodiments, the nanofluid 140 is heated to a temperature determined as a function of one or more factors. The factors can include a melting point of one or more components of the fixture(s), for example, a material of the body of the thermal-management system 100. A target heating temperature for the nanofluid 140 could be, for example, determined as a percentage of the melting point of the fixture, such as 70%.

References to a ‘body’ of the thermal-management system 100 herein refer to the primary system structure, or fixture components, such as shown primarily in FIGS. 2 and 3. The ‘body’ would not include, for instance, the pump and other components shown in FIG. 1, for example.

As another example, the target heating temperature could be the melting point of the relevant fixture minus a specific buffer, such as 50 Kelvin.

In one implementation, the target heating temperature for the nanofluid 140 is set to be a percentage of the melting point of the fixture, and then raised or lowered by a certain amount. As an example, the target heating temperature could be 70% of the fixture melting point minus 50 Kelvin.

In another example, the factors can include a melting point of the workpieces. A target heating temperature for the nanofluid 140 could be, for example, determined as a percentage of the melting point of one of the workpieces. In one implementation, the target heating temperature for the nanofluid 140 could be a percentage of the melting point of the workpieces, and then raised or lowered by a certain amount. As an example, the target heating temperature could be 100% of the workpieces melting point minus 50 Kelvin.

In some embodiments, the nanofluid 140 is cooled to a temperature determined as a function of one or more factors. The factors can include a crystallization rate for one or both workpieces 102, 104, or any constituent parts thereof. A target cooling temperature for the nanofluid 140 could be, for example, determined as a cooling rate 10% faster than the rate of the crystallization for the workpiece(s) 102, 104.

In one implementation, the target cooling temperature for the nanofluid 140 could be a temperature to achieve the desired cooling rate of the workpiece, and then raised or lowered by a certain amount. As just an example, the target heating temperature could be the desired cooling temperature minus 50 Kelvin.

Nanofluid 140 is for some cooling implementations cooled to a rate faster than the crystallization rate of one or both workpieces 102, 104.

Select control components of FIG. 1 are described below, primarily with reference to FIG. 2.

### III. FIG. 2

FIG. 2 is a side view taken along arrowed lines 2-2 of FIG. 1. The view shows the workpieces 102, 104 extending beyond an opening end 106 of the thermal-management system 100.

As shown, the body of the thermal-management system 100 can be configured (e.g., sized and shaped) to fit snugly around the workpieces 102, 104.

The workpieces 102, 104 can have various sizes with respect to the thermal-management system 100, and each could extend from the thermal-management system 100 by more than shown, less than shown, or not at all. In some implementations, one or both of the workpieces 102, 104 is recessed completely within in the thermal-management system 100 for the welding process. And, as mentioned, in a contemplated embodiment, the workpieces are enclosed by a body of the thermal-management system 100.

While each workpiece 102, 104 can have other shapes and dimensions without departing from the scope of the present disclosure, the workpieces are shown in FIG. 1 as being generally rectangular by way of example. The workpieces 102, 104 are shaped and sized according to manufacturing requirements for the product that the workpieces will be parts of.

In some embodiments, one or both workpieces 102, 104 has a thickness (measured vertically in the views of FIGS. 2 and 3) of between about 0.001 cm and about 2.0 cm.

Various sizes, shapes, and types (e.g., material) of workpieces 102, 104 can be used with the present thermal-management system 100. Example materials are described in more detail below, in the Workpiece Materials section (section XV.).

While the thermal-management system 100 can be made to have any appropriate size and shape without departing from the scope of the present disclosure, in some embodiments, an exterior of the thermal-management system 100 has generally rectangular top and side profiles, as shown in FIGS. 1 and 2.

While the thermal-management system 100 can be made to have any appropriate size and shape without departing from the scope of the present disclosure, in some embodiments, the exterior of the thermal-management system 100 has a length 204 (shown in FIG. 3) of between about 5 cm and about 100 cm. As further example, the thermal-management system 100 can have a height 205 of between about 0.5 cm and about 15 cm, and a width 150 (FIG. 1) of between about 5 cm and about 100 cm.

The thermal-management system 100 can include one or more of a wide variety of materials without departing from the scope of the present disclosure. Material must be configured to accommodate the fluid temperatures and any other effects to which the thermal-management system 100 may be exposed, such as thermal energy received indirectly from the workpieces 102, 104 during welding.

In a contemplated embodiment, the thermal-management system 100 includes more than one material. the thermal-management system 100 can include a first, more-conductive material, on the side(s) of the thermal-management system 100 that contact the workpieces 102, 104 and a less-conductive material on the side(s) opposite ambient environment or otherwise not directly adjacent the workpieces 102, 104 during operation of the thermal-management system 100.

Example materials for the body of the thermal-management system 100 could include steel, copper, aluminum, silicon, the like or other, for instance.

The side view of FIG. 2 shows by dashed lines interior, hidden-from-view, components of the thermal-management system 100. The components include the welding access ports 120, 122 shown in FIG. 1. While two welding access ports 120, 122 are shown, the thermal-management system 100 may include more or less welding access ports without departing from the scope of the present disclosure.

While the one or more ports 120, 122 can have any of a wide variety of shapes and sizes, without departing from the scope of the present technology, in various embodiments each port 120, 122 is generally circular (as shown in FIG. 1) and has a diameter 210 of between about 1 cm and about 4 cm.

The interior features shown by dashed line also include various portions of the inner fluid compartment or chamber 130. The chamber 130 can also have any of a wide variety of shapes and sizes. In one embodiment, the chamber is sized to hold between about 0.1 mL and about 1 L of nanofluid at one time.

The inner fluid chamber 130 has an exterior wall 220. The exterior wall 220 separates the chamber 130 from the workpieces 102, 104 and from an outside environment 222. The wall thickness 220 may vary, such as by being thicker (or thinner) at its sides that contact the workpieces 102, 104 than at its sides opposite ambient environment 222 or otherwise not directly adjacent the workpieces in operation. While the chamber wall 220 can have other thicknesses 224, in various embodiments the wall thickness 224 is between about 5 μm and about 1 mm.

The side view of FIG. 2 also shows the input component 136 (FIGS. 1, 2, and 3) and an outtake, or output component 232 (FIGS. 2 and 3).

The input and output components 136, 232, as with all input and output components described herein, can take any of a wide variety of forms. The components 136, 232 may include valves, ports, manifold arrangements, couplings, combinations of these, or similar inlet or outlet features. The input and output components are referenced herein primarily as valves, for simplicity and not to limit the configurations and arrangements that these input/output components can take.

The valves 136, 232 are used to add nanofluid 140 to the thermal-management system 100 and retrieve or otherwise allow outflow of nanofluid from the thermal-management system 100.

The nanofluid 140 can be moved through the thermal-management system 100 in any of a variety of ways including by one or more of pushing, such as by an upstream pump, pulling, such as by a downstream pump, gravity, convection or heat-gradient currents, capillary action, or a combination of any of these.

Nanofluid 140 can be added to the thermal-management system 100 according to any suitable timing. One goal of replacing, or replenishing the nanofluid 140 is maintaining a desired in-system fluid temperature. Hot nanofluid 140, being positioned in the chamber 130 and having an original target temperature, in heating the workpiece, by way of the chamber walls 220, itself 140 cools due to loss of the energy causing heating of the workpiece(s) 102, 104. The replenishing nanofluid would thus return temperature of the fluid 140 in the chamber to the original target temperature or maintain the temperature of the fluid 140 in the chamber at the original target temperature.

In some implementations, the nanofluid 140 is added and removed generally continuously to refresh the nanofluid 140 with fluid of the desired temperature and/or other qualities, to maintain the desired thermal-management system 100 temperature, for affecting temperature of the workpieces 102, 104 and the welding area as desired.

In one embodiment, a hot nanofluid 140 is passed through the thermal-management system 100 at a pre-determined temperature and flow rate to pre-heat the workpiece(s) 102, 104 before welding. Flow can continue at that rate or slow or stop once welding has started, during the welding, and/or after the welding.

In some embodiments, some or all of the fluid control described (e.g., flow rate, temperature) are automated. The automated features may include, for instance, selectively heating or cooling the nanofluid 140, and selectively causing the nanofluid 140 to flow into or out of the thermal-management system 100—by pumping, for instance.

The nanofluid 140 could, as referenced, also be altered in ways other than temperature. By automated machinery and/or personnel using tools, a magnetic polarity of the nanofluid 140 can be changed, a type or types of nanoparticles in the nanofluid 140 can be changed, a concentration of any of the types of nanoparticles in the fluid 140 can be changed, and/or nanoparticles or base fluid can be added/removed to/from the nanofluid 140 to change the ratio of fluid constituent parts.

Example automated features are shown in FIG. 1. The automated features can include a controller 170.

The controller 170 is configured and arranged for communication with one or both of a pump 172 and at least one fluid modification device (FMD) 174. The configuration and arrangement of the controller 170 can include wired or wireless connection to the pump 172 or FMD 174.

Fluid control can include monitoring of fluid characteristics, such as by closed-loop or control-loop feedback, as mentioned. For instance, at least one sensor monitoring fluid temperature and/or other fluid characteristic (e.g., magnetic polarity, ratio of nanoparticles and base fluid) can be implemented at any of various portions of the arrangement. Example locations include any one or more of: an outlet of the FMD 174 (reference numeral 173¹) an inlet of the FMD, and inlet to a reservoir 176, an outlet of the reservoir 176, an inlet of the sleeve system 100 (reference numeral 173²), and an outlet of the sleeve system 100. The feedback loop can have benefits for the controller including advising whether the FMD 174 is performing as it is being instructed to perform, whether the controller 170 is sending proper signals or should send different signals—e.g., a signal to heat more or change fluid composition in a different manner. The feedback can also promote efficiency, such as when the sensor is at the FMD inlet, in that the controller 170 can consider a particularly what change(s) need to be made to the fluid at the FMD 174 to reach a target fluid characteristic(s) pre-determined at the controller 170 (e.g., target temperature and/or composition).

The controller 170, and the coding and functions thereof, is described further below in the controller section, (section XIV.) below.

The thermal-management system 100 can include or be connected to the reservoir 176, holding the nanofluid 140 before and/or after it leaves the system chamber 130. Reference numeral 99 indicate fluid from the system 100 flowing into the reservoir 176.

The reservoir 176 is a storage or transition device where the nanofluid 140 can be added, removed, or replaced in mass, e.g., in total, at one time or over a period of time. The nanofluid 140 can be adjusted by a fluid-modification device, described more below.

In some embodiments, the thermal-management system 100 includes or is connected to more than one reservoir 176. The reservoir(s) 176 can hold the same or different types of nanofluids 140. The reservoir(s) 176 could also, whether holding the same or different types of nanofluid, maintain the nanofluids 140 at different temperatures. One of the reservoirs 176 could be a hot reservoir, for example, with the other being cold. An FMD 174 can include a heater being part of or connected to a hot reservoir 176, and the same or separate FMD 174 can include a chiller being part of or connected to a cold reservoir 176.

As provided, any component shown by a single item in the figures can be replaced by multiple such items, and any multiple items can be replaced by a single item. Here, for instance, though a single pump 172 is shown in FIG. 1, the thermal-management system 100 can include or be connected to more than one pump 172. Similarly, while a single FMD 174 is shown, the thermal-management system 100 can include more than one.

The FMD 174 can configured to alter the nanofluid 140 in any of a variety of ways toward accomplishing goals of the technology. The FMD 174 can include, for example, a heater, for heating nanofluid 140 passing through the FMD 174 to a specified temperature before it is pumped into the fluid chamber 130.

In one embodiment, the FMD 174 includes a chiller, or cooling device to cool nanofluid 140 passing through the FMD 174 to a specified temperature before it is pumped into the fluid chamber 130.

In various embodiments, the FMD 174 includes a material-adjusting component for changing a make-up or characteristic of the nanofluid 140 outside of or along with temperature. The material-adjusting component can be configured to, for example, alter the nanofluid 140 in one or more ways, such as by changing a magnetic polarity of the nanofluid 140, changing the type or types of nanoparticles in the nanofluid 140, or by changing a concentration of any of the types of nanoparticles in the fluid 140, by adding or removing nanoparticles or base fluid to/from the nanofluid 140, to obtain desired qualities.

In embodiments in which the FMD 174 illustrated represents more than one FMD 174, or an FMD 174 with various functions, the FMD 174 can include any combination of abilities, such as that of a heater, a chiller, and/or a material-adjusting component.

The thermal-management system 100 includes any appropriate piping, valves, switches, and the like for directing the nanofluid 140 between the various components described in operation of the thermal-management system 100.

With continued reference to FIG. 2, the in-/out-takes 136, 232 can vary in design. They can have any number, size, shape, and position within the thermal-management system 100 without departing from the scope of the disclosure, for instance.

In the example of FIG. 2, the intake 136 is shown above the outtake 232. A benefit of this arrangement is that gravity is harnessed to lessen the amount of work needed to move the nanofluid 140 through the thermal-management system, as compared to if the fluid flow were reversed—i.e., from a lower intake to an higher outtake.

In one embodiment at least one outtake 232 is positioned at generally the same elevation as at least one intake 136.

As provided, the thermal-management system 100 in various embodiments comprises one or more interior structures, other than that shown in the figures, for controlling direction and/or position of nanofluid 140 within the chamber 130. Example structures include baffles, dividers, walls, or the like. The chamber 130 can thus be divided into one or more separate or contiguous sub-chambers.

The internal structure can serve purposes such as ensuring that the nanofluid 140 flows through the thermal-management system 100 as desired or predetermined. The desired or predetermined flow may include, for instance, that the nanofluid 140 flows in such a way as to maintain desired temperature at the wall(s) 220 that would be adjacent the workpieces 102, 104 during operation of the thermal-management system 100.

As mentioned, in some implementations of the present technology, nanofluid 140 of one temperature is passed through the thermal-management system 100 at one point in a welding process and nanofluid 140 of another temperature is passed through the thermal-management system 100 at another point in the process. This can include, for instance, passing hot nanofluid 140 through the thermal-management system 100 in a pre-heating, pre-welding stage, and/or during welding, and then replacing that with cold nanofluid 140 at any time during and/or after the welding energy is applied.

In one implementation, fluid of one temperature (e.g., a hot temperature) is flushed by fluid of another temperature (e.g., a cold temperature) replacing it. In another implementation, fluid of one temperature (e.g., a hot temperature) is flushed out at least substantially by an intermediate-temperature fluid, and then the fluid of the other temperature (e.g., cold temperature) is added.

In a contemplated embodiment, the same fluid used as the hot fluid is cooled rendering the cold fluid, instead of flushing, and/or vice versa—i.e., a cold fluid is heated, rendering the hot fluid.

In another contemplated embodiment, fluid is heated and/or maintained heated in one location (e.g., a first chamber) for use in pre-welding and/or during welding, and the cold fluid is chilled and/or maintained cold in a separate location (e.g., a second chamber) for use in the heat exchanger during and/or immediately post welding.

For embodiments in which the fluid chamber 130 has various compartments, or sub-chambers, like the example of FIG. 4, more than one temperature of nanofluid 140 could be present in the thermal-management system 100, to accomplish their respective functions (e.g., cooling, for one, and heating, for the other) simultaneously, or in closely adjacent time windows.

### IV. FIG. 3

FIG. 3 is a cross-sectional side view, taken along arrowed lines 3-3 of FIG. 1. The view is like the side view of FIG. 2, although in the cross-sectional view many of the internal components of the thermal-management system 100 are exposed to the view, and so shown by solid lines.

The thermal-management system 100 can be considered to have a first, or upper section 302 and a second or lower section 304. The thermal-management system 100 is configured so that the first section 302 is positioned adjacent the first workpiece 102, primarily, while the second section 304 is positioned adjacent the second workpiece 104.

As referenced above, in some embodiments (not shown in detail) the thermal-management system 100 includes only one of the upper and lower sections 302, 304, or includes both sections being fluidly separate. That is, the first section 302 can be configured and arranged to be used alone—e.g., having its own intake and outtake ports, and not being connected in a rear area 306 to any second section 304. A rear portion 308 of the first section 302 could simply be capped there at its back end, for example.

The same applies to the second section 304. Thus, the second section 304 can be configured and arranged to be used alone—e.g., having its own intake and outtake ports, and not being connected at the rear area 306 to any first section 302.

The two sections 302, 304, though distinct, can be used at the same time. In a contemplated embodiment, the two sections 302, 304 are not connected fluidly, but are connected mechanically, such as by bracing arms extending between the two sections 302, 304.

Similarly, either or both of two side sections 160, 162 (called out in FIG. 1) of the thermal-management system 100 can be separate from, and used separate or together with, each other and/or one or both of the upper and lower sections 302, 304. Using at least one side section 160 could be beneficial in scenarios in which an area to be welded is at or near an edge of the workpieces. In this case, the side section 160 would operate to heat and/or cool the area to be welded, being welded, or just welded, depending on how the side section 160 is used. Energy, fluid, cost, and the like can be saved in such cases by using sections needed for the particular scenario, but not more.

As provided, the thermal-management system 100 can have any appropriate size and shape without departing from the scope of the present disclosure. In some embodiments, the inner fluid chamber 130 has one or more heights 320 being between about 0.1 cm and about 5 cm.

Benefits of having a lower-height, thin, or low-profile, inner-fluid chamber 130, include minimizing or avoiding temperature gradients within the fluid 140 along the height 320 of the chamber 130. Thereby, the nanofluid 140 is more likely to consistently have the target temperature, e.g., for heating or cooling the workpiece(s) 102, 104 as the case may be.

Another example benefit of having a thin, low-profile, inner-fluid chamber 130, is that less nanofluid 140 is needed to fill the chamber 130 or otherwise to ensure the fluid 140 contacts the chamber wall(s) where and as much as needed for robust conduction between the fluid 140 and the wall(s).

### V. FIG. 4

FIG. 4 shows a top cross-sectional view of a thermal-management system 400 according to another implementation. The view is like the top view of FIG. 1, except for having a top wall of the thermal-management system 400 removed to expose some internal components.

As mentioned, the thermal-management system according to the current technology can include one or more interior structure for controlling direction and/or position of nanofluid within a chamber. And, particularly, in some embodiments, the chamber includes at least two sub-chambers, whereby a first nanofluid of a first temperature can be provided for the first sub-chamber, and a second nanofluid of a second temperature provided for the second sub-chamber. The thermal-management system 400 of FIG. 4 is an example of these embodiments.

The thermal-management system 400 of FIG. 4 includes a first inner fluid chamber 402 and two second inner fluid chambers 404, 406.

In a contemplated embodiment (not shown in detail), the first inner fluid chamber 402 is not present, and only one or more second inner fluid chambers 404, 406 are present. The remaining chambers can be configured, arranged, and used to preheat the workpieces or welding structure leading up to and perhaps during a welding. The same chamber(s) can also or instead be used for rapid cooling after welding.

With further reference to FIG. 4, the second chambers 404, 406 are connected to input piping 408 extending from an input valve 410, and output piping 412 extending to an outtake valve 414.

FIG. 4 also shows example intake and outtakes 416, 418 for the first chamber 402. The piping and ports are shown by way of example and can have any size, shape, number, and material without departing from the scope of the present technology.

The type and temperature of the nanofluid(s) 140 used, and positioning and flow of the nanofluid(s) 140 into and out of the chambers 402, 404, 406 can be effected according to any of the manners and techniques described herein. In one embodiment, a first nanofluid 140¹ having a first temperature is pumped or otherwise moved through the first chamber 402, while a second nanofluid 140² having a second temperature is pumped or otherwise moved through the second chambers 404, 406. The nanofluids 140¹, 140² can be the same or similar, e.g., having the same or similar structure and constituent parts, or be different in any one or more ways.

The first and the second temperatures of the nanofluids 140¹, 140² can be different, such as by one being higher (e.g., hot) compared to the other (e.g., cold). In some embodiments, the temperatures of one or both of the fluids are changed over time, such as during the welding process (pre-welding, during welding, and/or after the welding), to accomplish particular goals. It is possible, in some implementations, then, that the nanofluids 140¹, 140² have different temperatures at some times of the welding process, while at other times in the welding process (e.g., just after the welding), their temperatures are controlled toward a similar (e.g., cool) temperature.

An interface 430 between the first chamber 402 and second chamber(s) 404, 406 can be insulated or otherwise configured (size, shape, material) and arranged (e.g., positioned in the thermal-management system 400) to inhibit energy transfer between the first chamber 402 and second chamber(s) 404, 406. The interface 430 could have relatively thick walling, for instance, an insulating material (e.g., rubber), and/or one or more intermediate fluid layers (e.g., air).

In a contemplated embodiment, the interface 430 between the first chamber 402 and second chamber(s) 404, 406 is configured and arranged to allow energy to pass through it, or at least is not specially configured and arranged to inhibit the transfer. Such an arrangement could promote desired transfer of thermal energy transfer between the first chamber 402 and second chamber(s) 404, 406.

As just an example, after flowing hot nanofluid 140² through the second chambers 404, 406 to preheat weld areas 450, cold nanofluid 140¹ can be introduced to the first chamber 402 to cool the workpieces 102, 104 adjacent the first chamber 404, and also to begin to cool the second chamber(s) 404, 406, thereby cooling the workpieces and the forming or newly formed weld joint. The second chambers 404, 406 could at the same time—or starting before or after the cold nanofluid 140¹ is introduced—be replenished with cold nanofluid 140², also operating then to cool the workpieces 102, 104 and the forming or newly formed weld joint.

### VI. FIG. 5

FIG. 5 shows a thermal-management system 500 according to another embodiment of the present technology. The thermal-management system 500 is configured and arranged to affect the thermal qualities of one or both of the workpieces 102, 104, being welded together.

The thermal-management system 500 comprises two upper fixtures 502, 504 and a lower fixture 506. The upper fixtures 502, 504 are shown separated by a gap 505. The upper fixtures 502, 504 can be connected to each other, such as by bracing arms (not shown in detail), or unconnected. The lower fixture 506 is shown divided generally into two.

The lower fixture 506 can include two primary sides separated from each other or connected partially, such as by being separated by a trough 570 and fixture material adjacent (e.g., below) the trough, as shown. Including the trough 570, or otherwise including a space below the lower workpiece 104 at a vicinity of the welding, has benefits including scattering of the laser beam during laser welding.

Each fixture 502, 504, 506 is configured (e.g., sized and shaped) and arranged (e.g., positioned) to receive input nanofluid. An input 510 to the first fixture 502 is indicated by arrowed line directed toward the fixture 502. The first fixture 502 includes a first internal channel or path 512, shown by dashed line, through which the nanofluid flows. The path 512 can be formed in a variety of ways such as in a molding process forming the fixture 502. An output 514 is indicated by arrowed line leaving the fixture 502.

A designer of the thermal-management system can engineer the intra-fixture fluid pathways (512, etc.) in any of a wide variety of shapes to achieve desired goals, including heat-distribution goals within the fixtures 502, 504, 506. In some embodiments, as shown in FIG. 5, at least one of the intra-fixture fluid pathways is generally serpentine, or winding. A benefit of this arrangement is that more of the channeling 512 is adjacent more of a surface of the fixture 502 adjacent the workpiece(s) 102, 104.

As shown in FIG. 9, another shape for the pathways 512, etc. include being generally “U” or “C” shaped (channels 808, 814), by way of example.

The second upper fixture 504 includes an input 516, an internal fluid channel or pathway 518, and an output 520, similarly.

Flow of fluid to the channels or pathways 512, 518 is in various embodiments controlled by a switching device 522. The device 522 may include or be connected to appropriate structure for accomplishing the fluid control, such as pumps, controllable valves, circuitry and controls (e.g., computer).

The thermal-management system 500 is in some embodiments also connected to or includes one or more fluid reservoirs 524, 526. In the example of FIG. 5, the first reservoir 524 represents a cold nanofluid 524 reservoir, and the second reservoir 526 represents a hot fluid reservoir.

The thermal-management system 500 can include or be associated with heating or chilling equipment, to heat or cool the nanofluid as desired or predetermined. The equipment can be like any of the FMD described above. The equipment can be a part of the reservoirs, for example. In one embodiment, the equipment is controlled by circuitry, such as by the same computerized controller controlling the switch 522.

The lower fixture 506 includes at least one input, internal fluid pathway, and output, like the upper fixtures 502, 504. In the illustrated embodiment, the fixture 506 includes two inputs 530, 540, feeding respective internal fluid pathways 532, 542 leading to respective outputs 534, 544.

While connections are not shown expressly, the inputs/outputs 550, 560 for the lower fixture 506 can be connected to the same switch 522 and/or reservoirs 524, 526 shown connected to the first and second fixtures 502, 504. In one embodiment, the inputs/outputs 550, 560 for the lower fixture 506 are connected to one or more separate arrangements, including, e.g., a switch and hot and cold reservoirs.

The embodiment of FIG. 5 can be otherwise like the embodiments described above, and every similarity is not repeated here. Processes for controlling the temperature, flow, and timing of changes thereof, can be made according to any of the techniques described herein, including those described above in connection with the embodiments of FIGS. 1-4.

For instance, for the embodiment of FIG. 5, too, hot nanofluid can be passed through the fixtures 502, 504, 506 in advance of welding, to pre-heat the workpieces 102, 104, thereby facilitating the welding process, as described. During or just after welding of the workpieces 102, 104 together, cold fluid can be introduced adjacent one or both workpieces to achieve benefits described above.

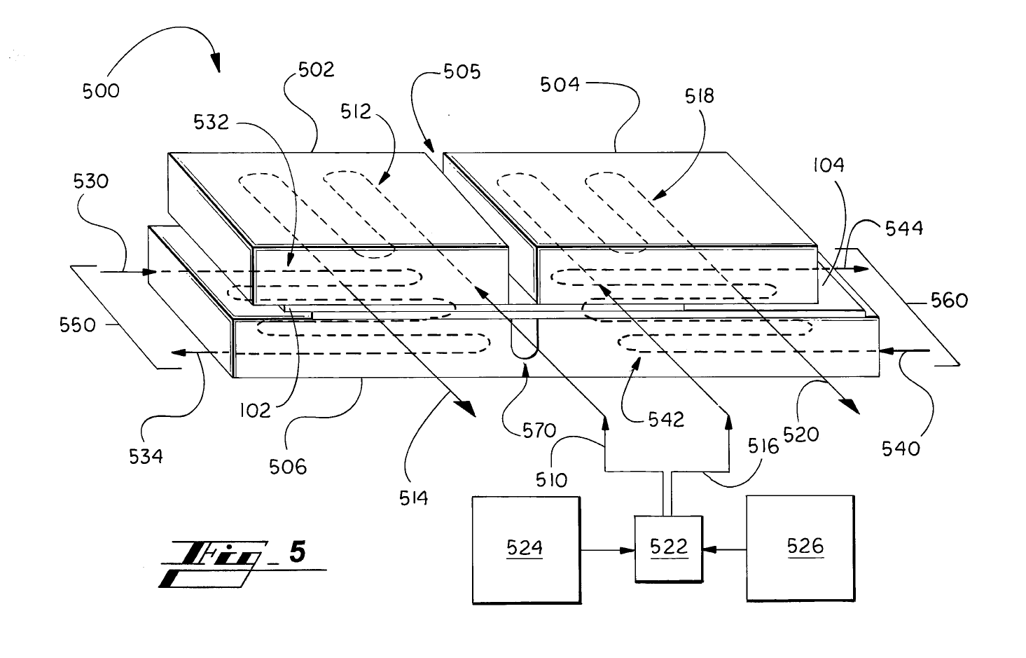

### VII. FIG. 6

FIG. 6 shows a thermal-management system 600 according to another embodiment of the present technology. The thermal-management system 600 is configured and arranged to affect the thermal qualities of one or both of the workpieces 102, 104 being welded together.

The thermal-management system 600 is substantially similar to the embodiment of FIG. 5, except fluid pathways for the lower fixture 602 are not present.

The embodiment of FIG. 6 can otherwise be like the embodiments described above, and every similarity is not repeated here. Processes for controlling fluid temperature, composition, and flow, and timing of changes thereof, can be made according to any of the techniques described herein, including those described above in connection with the embodiments of FIGS. 1-5.

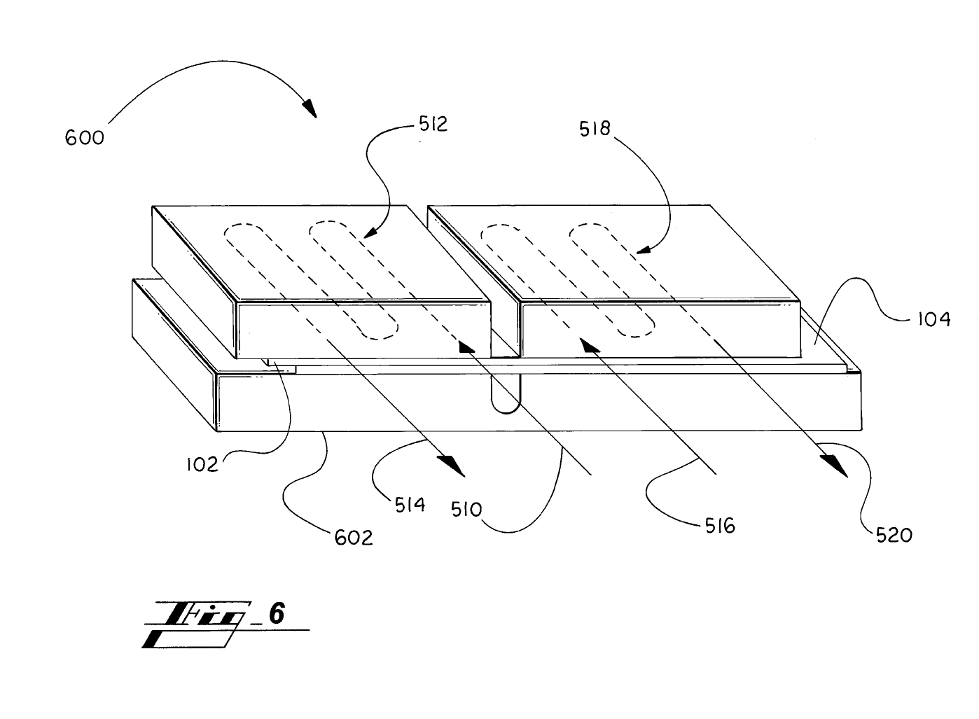

### VIII. FIG. 7

FIG. 7 shows a thermal-management system 700 according to another embodiment of the present technology. The thermal-management system 700 is configured and arranged to affect the thermal qualities of one or both of the workpieces 102, 104 being welded together.

The thermal-management system 700 is substantially similar to the embodiments of FIGS. 5 and 6, except the fluid pathways passing through the first and second upper fixtures 702, 704 are turned to some degree (about 90 degrees, by way of example) with respect to the pathways shown in the embodiment of FIGS. 5 and 6.

Particularly, system input/outputs 720, 730 (including inputs 706, 712 and outputs 710, 716) to and from first and second fixtures 702, 704 of FIG. 7 are associated with lateral ends of the fixtures 702, 704, instead of sides of the fixtures 502, 504 as shown in FIG. 5.

The embodiment of FIG. 7 can otherwise be like the embodiments described above, and every similarity is not repeated here. Processes for controlling fluid temperature, composition, and flow, and timing of changes thereof, can be made according to any of the techniques described herein, including those described above in connection with the embodiments of FIGS. 1-6.

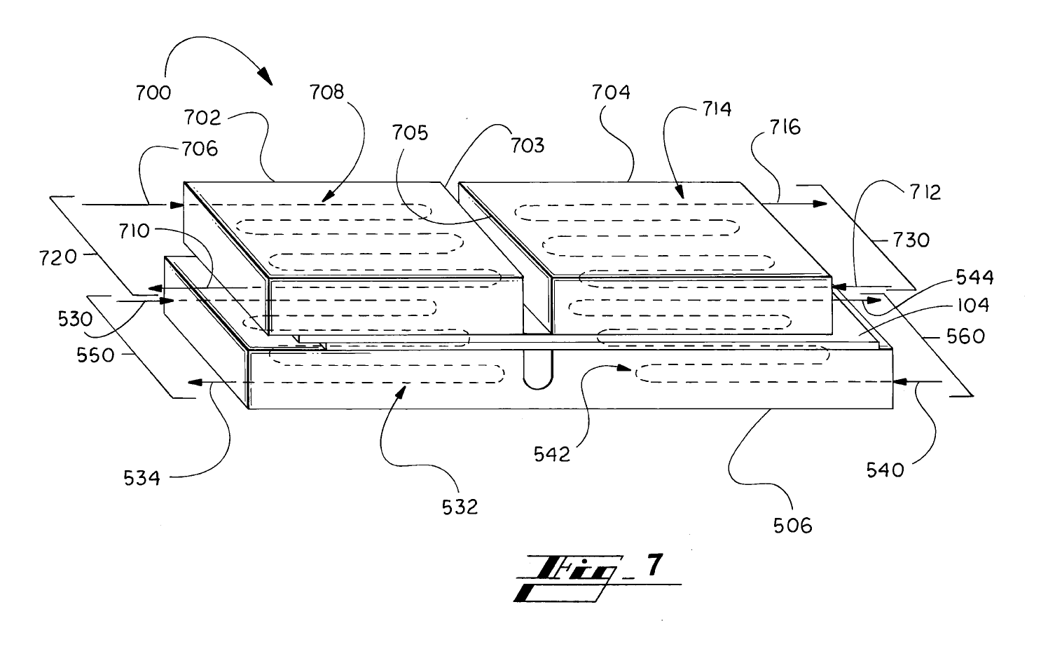

### IX. FIG. 8, WITH REFERENCE TO FIG. 9

FIG. 8 shows a thermal-management system 800 according to another embodiment of the present technology. The thermal-management system 800 is similar to other systems disclosed in many ways, being configured and arranged to affect the thermal qualities of one or both of the workpieces 102, 104 being welded together.

Particularly, the thermal-management system 800 has features of the embodiments of FIGS. 6 and 7, with some noted similarities and distinctions.

The thermal-management system 800 includes a lower block 602, similar to that in the embodiment of FIG. 6. The thermal-management system 800 also includes two upper fixtures 802, 804, that are similar to the upper fixtures 702, 704 of FIG. 7.

The upper fixtures 802, 804 of FIG. 8 differ from those of FIG. 7 primarily in having their inner walls 803, 805 slanted, as compared to the more-vertically disposed walls 703, 705 shown in FIG. 7.

As shown in FIG. 9, the thermal-management system 900 can be different also by the intra-fixture fluid pathways having a different configuration—e.g., shape—than those of FIGS. 6 and 7. In FIG. 9, the channels not visible in FIG. 8 are shown as being generally “U” or “C” shaped, while the channels of earlier embodiments were generally serpentine, or winding, by way of example.

The upper fixture inputs 806, 810 and 812, 816 (FIG. 9) can be like those for the upper fixtures of FIG. 7.

The embodiment of FIG. 8 can otherwise be like the embodiments described above, and every similarity is not repeated here. Processes for controlling fluid temperature, composition, and flow, and timing of changes thereof, can be made according to any of the techniques described herein, including those described above in connection with the embodiments of FIGS. 1-7.

### X. FIG. 9

FIG. 9 shows a see-through view of the thermal-management system 800 of FIG. 8. The inner fluid pathways 808, 814, are thus visible.

As with all embodiments described herein, the particular layout of fluid chambers or pathways can be engineered to any of a wide variety of shapes and sizes to best fit the application and desired results.

It is noted, for example, that while the inputs and outputs to/from the upper fixtures 702, 704 of FIG. 7 are similar in location to the inputs and outputs to/from the upper fixtures 802, 804 of FIGS. 8 and 9, the internal fluid pathways 908, 914 shown in FIG. 9 are shaped differently than the fluid pathways 708, 714 shown in FIG. 7.

The embodiment of FIG. 9 can otherwise be like the embodiments described above, and every similarity is not repeated here. Processes for controlling fluid temperature, composition, and flow, and timing of changes thereof, can be made according to any of the techniques described herein, including those described above in connection with the embodiments of FIGS. 1-8.

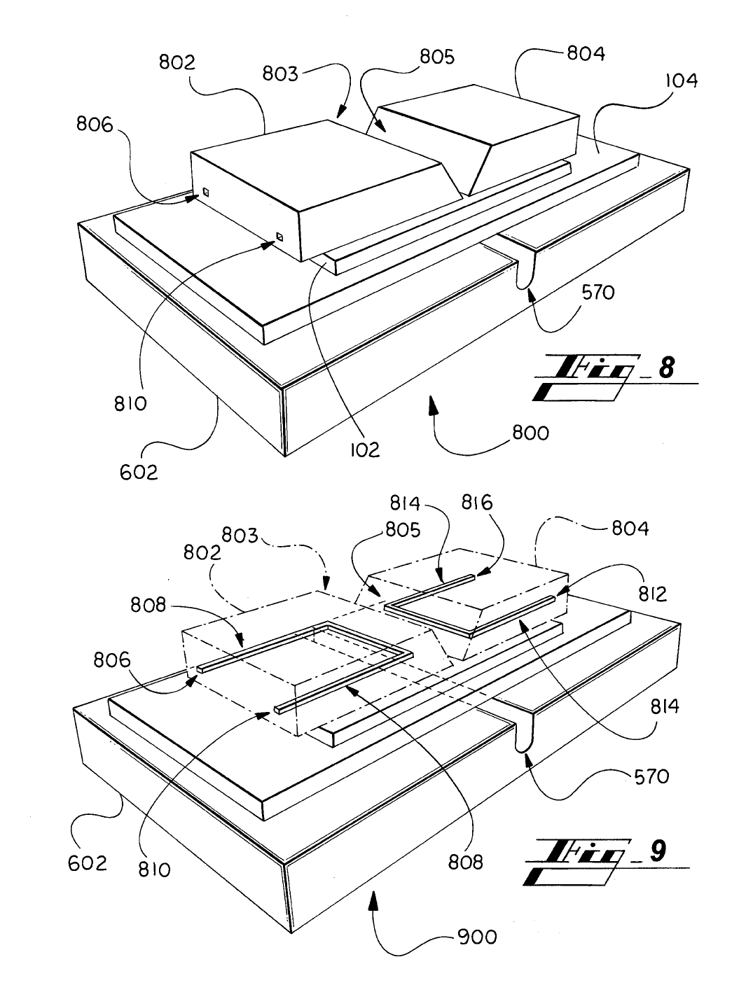

### XI. FIG. 10

FIG. 10 shows a welding apparatus fixture 1006 of a thermal-management system.

The fixture 1006 can be used alone, adjacent (e.g., above, below, or aside) workpieces 102, 104 (not shown in FIG. 10) to be joined.

The fixture 1006 can be a top or bottom fixture, for instance. In some implementations, the fixture 1006 is used opposite any of the fixtures, upper or lower, shown and described in connection with FIGS. 1-9.

The embodiment of FIG. 10, shows another possible nanofluid path 1032, receiving nanofluid from an input 1030 and passing the nanofluid to an output 1034. As shown, the nanofluid path 1032 traverses generally an entirety of the fixture 1006. The particular path, again, can vary from that shown, as determined suitable for the application and desired results by a system designer.

A consideration for the design of the thermal-management system can be the potential presence of a void, or trough 1070. The trough 1070 is shown to have a smaller height, e.g., relative to the height of the fixture 1006, than the troughs shown in FIGS. 5-9. The nanofluid pathway 1032 would be designed either to avoid the trough 1070, as shown in FIG. 10, or fully or partially traverse the trough 1070.

The embodiment of FIG. 10 can otherwise be like the embodiments described above, and every similarity is not repeated here. Processes for controlling fluid temperature, composition, and flow, and timing of changes thereof, can be made according to any of the techniques described herein, including those described above in connection with the embodiments of FIGS. 1-9.

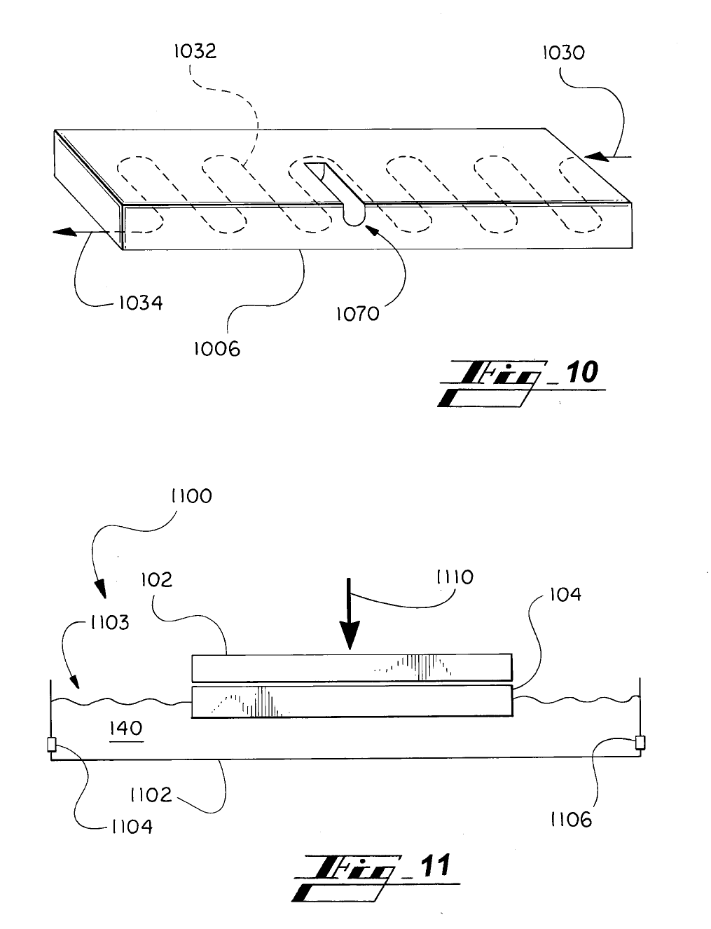

### XII. FIG. 11

As referenced in the Summary, above, in some embodiments a thermal-management system is arranged so that the nanofluid contacts directly one or both workpieces 102, 104 being joined.

FIG. 11 shows an embodiment of such a thermal-management system 1100. The thermal-management system 1100 comprises a nanofluid container or housing 1102 for creating a nanofluid bath, or pool 1103 for holding the nanofluid 140.

The nanofluid housing 1102 can be sized and shaped in any of a wide variety of manners, and include any of a variety of materials.

The nanofluid housing 1102 in some embodiments includes input/output ports 1104, 1106. The ports can be used to cycle different nanofluid through the housing 1102, having different temperature and/or composition. As described above, the nanofluid can be changed by a heating or chilling device or other fluid modification device (FMD). The FMD may be configured to change a magnetic polarity of the nanofluid 140 as desired or predetermined, for example. In one embodiment, the nanofluid housing 1102 includes or is connected to such an FMD.

A welding action is shown schematically in FIG. 11 by arrow 1110. The thermal-management system 1100 may include or be used with workpiece-supporting structure, such as a brace or base (not shown in FIG. 11). The structure could help, for example, stabilize the workpieces for the welding step. In one contemplated embodiment, the structure is at least partially disposed in the fluid 140. And in one embodiment the structure is submersed fully or substantially fully in the fluid 140 during welding.

In a contemplated embodiment, the supporting structure is partially or fully outside of the fluid 140 and may be connected to, for instance, walls of the housing 1102. The structure is configured (e.g., sized and shaped) and arranged to support, hold and/or secure the workpieces 102, 104 from unwanted movement.

The embodiment of FIG. 11 can otherwise be like the embodiments described above, and every similarity is not repeated here. Processes for controlling fluid temperature, composition, and flow, and timing of changes thereof, can be made according to any of the techniques described herein, including those described above in connection with the embodiments of FIGS. 1-10.

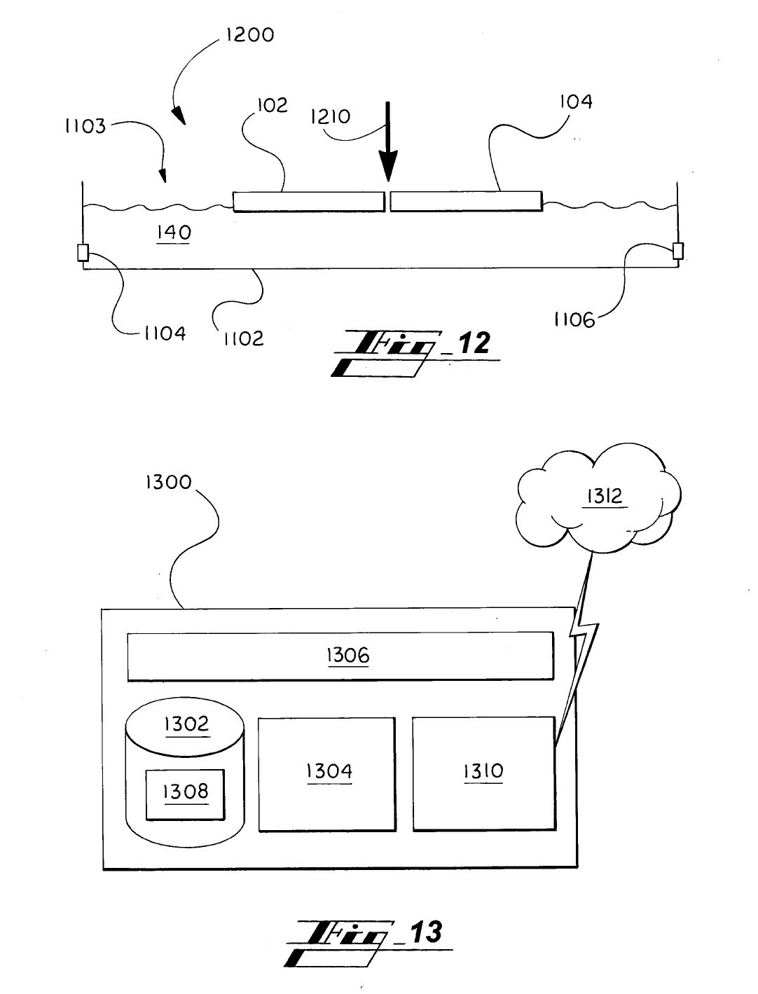

### XIII. FIG. 12

FIG. 12 shows another embodiment of a thermal-management system 1200 in which the nanofluid 140 contacts directly one or both workpieces 102, 104 being welded together.

The thermal-management system 1200 of this embodiment differs from that of FIG. 11 primarily by the arrangement of the workpieces 102, 104 in the nanofluid bath 1103 of FIG. 12 versus the arrangement of the workpieces 102, 104 in the nanofluid bath 1103 of FIG. 11.

In the embodiment of FIG. 12, the workpieces 102, 104 are positioned side-by-side, and the welding action 1210 acts between them as shown schematically.

As with the thermal-management system 1100 of FIG. 11, the thermal-management system 1200 may include or be used with workpiece-supporting structure, such as a brace or base. The structure could help stabilize the workpieces for the welding step, for example. In one contemplated embodiment, the structure is at least partially disposed in the fluid 140. And in one embodiment it is submersed fully or substantially fully in the fluid 140 during welding. In another contemplated embodiment, the supporting structure is partially or fully outside of the fluid 140 and may be connected to, for instance, walls of the housing 1102. The structure is configured (e.g., sized and shaped) and arranged to support, hold and/or secure from movement the workpieces 102, 104.

The inlet/outlet 1104, 1106 are described above

The embodiment of FIG. 12 can otherwise be like the embodiments described above, and every similarity is not repeated here. Processes for controlling fluid temperature, composition, and flow, and timing of changes thereof, can be made according to any of the techniques described herein, including those described above in connection with the embodiments of FIGS. 1-11.

### XIV. FIG. 13

FIG. 13 shows an example controls system 1300, such as a computing apparatus, or computer.

The thermal-management system 1300 can constitute the controls 170, mentioned above, and can be a part of or control the switching device 522 also described.

The controls system 1300 includes a memory, or computer-readable medium 1302, such as volatile medium, non-volatile medium, removable medium, and non-removable medium. The term computer-readable media and variants thereof, as used in the specification and claims, refer to tangible, non-transitory, storage media.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The controls system 1300 also includes a computer processor 1304 connected or connectable to the computer-readable medium 1302 by way of a communication link 1306, such as a computer bus.

The computer-readable medium 1302 includes computer-executable code or instructions 1308. The computer-executable instructions 1308 are executable by the processor 1304 to cause the processor, and thus the controller 1300, to perform any combination of the functions described in the present disclosure.

Example functions or operations described include controlling a temperature of nanofluid being introduced to the thermal-management system of any of the embodiments shown and described. Another example function is changing nanofluid composition in a pre-determined manner to expedite or otherwise effect as desired a heating or cooling process. Another example function includes controlling a flow or flow rate by which the nanofluid is caused to flow through any of the example thermal management systems described or shown.

The code or instructions 1208 can be divided into modules to perform various tasks separately or in any combination. The module can be referred to by any convenient terminology. One module, configured with code to control one or more characteristics of the nanofluid using an FMD, could be referred to as a fluid-modification module, a fluid-characteristic-control module, or the like, for instance.

Still another example function mentioned is control of automated machinery, such as robotics. A robot (not shown in detail) can be configured and arranged to be controlled to prepare the workpieces 102, 104 (e.g., treat, coat, adjust the material, shape or size, etc.) position one or both workpieces 102, 104 adjacent any of the thermal-management systems, for instance, and/or position such system or such component(s) adjacent the workpiece(s).

The controller 1300 can also include a communications interface 1310, such as a wired or wireless connection and supporting structure, such as a wireless transceiver. The communications interface 1310 facilitates communications between the controller 1300 and one or more external devices or systems 1312, whether remote or local.

The external devices 1312 can include, for instance, a remote server to which the controls system 1300 submits requests for data and/or from which the controls system 1300 receives updates or instructions. The external device 1312 could include a computer from which the control system 1300 receives operating parameters, such as target temperatures for the nanofluid(s), other target characteristics for or related to the fluid, heating or cooling times, nanofluid flow rates, flow or switch timing, or another thermal management system characteristic.

### XV. WORKPIECE MATERIALS

As mentioned, various types of workpieces 102, 104 can be used with the present thermal-management systems.

The workpieces 102, 104 being welded together can be similar or dissimilar, as mentioned. Regarding dissimilar workpiece materials, one workpiece can be a plastic or other polymer, for instance, and the other can be steel, aluminum, an alloy, or other metal. The teachings of the present disclosure can be used to join a polymer (e.g., polymeric composite) to another polymer, or to join a polymer to a metal, for instance.

In one embodiment, the material of one or both workpieces 102, 104 includes polyethylene. In various implementations, the material includes polyethylene terephthalate (PET), high density polyethylene (HDPE) and/or ethylene vinyl alcohol (EVOH).

In one embodiment, at least one of the workpieces 102, 104 being joined includes a polymer. At least one of the workpieces 102, 104 can include synthetic, or inorganic, molecules. While use of so-called biopolymers (or, green polymers) is increasing, petroleum based polymers are still much more common.

Material of one or both workpieces 102, 104 may also include recycled material, such as a polybutylene terephthalate (PBT) polymer, which is about eighty-five percent post-consumer polyethylene terephthalate (PET).

In one embodiment one or both of the workpieces 102, 104 includes some sort of plastic. In one embodiment, the material includes a thermo-plastic.

In one embodiment one or both of the workpieces 102, 104 includes a composite. For example, in one embodiment one or both of the workpieces includes a fiber-reinforced polymer (FRP) composite, such as a carbon-fiber-reinforced polymer (CFRP), or a glass-fiber-reinforced polymer (GFRP). The composite may be a fiberglass composite, for instance. In one embodiment, the FRP composite is a hybrid plastic-metal composite.

The material of one or both workpieces 102, 104 in some implementations includes a polyamide-grade polymer, which can be referred to generally as a polyamide.

Material of one or both workpieces 102, 104 may also include includes polyvinyl chloride (PVC).

In one embodiment, the material of one or both workpieces 102, 104 includes acrylonitrile-butadiene-styrene (ABS).

In one embodiment, the material of one or both workpieces 102, 104 includes a polycarbonate (PC).

Material of one or both workpieces 102, 104 may also comprise a type of resin. Example resins include a fiberglass polypropylene (PP) resin, a PC/PBT resin, and a PC/ABS resin.

The workpieces 102, 104 may be pre-processed, such as heated and compression molded prior to the welding.

As mentioned, any of the operations can be performed, initiated, or otherwise facilitated by automated machinery, such as robotics. A robot (not shown in detail) can be configured and arranged to be controlled to prepare the workpieces 102, 104 (e.g., treat, coat, adjust the material, shape or size, etc.) position one or both workpieces 102, 104 adjacent any of the thermal-management systems, for instance, and/or position such system or such component(s) adjacent the workpiece(s).

A robot could also control the welding equipment, or the welding equipment itself can itself be automated, or robotic.

Any such automated machinery in one embodiment is controlled by a controller, such as by any of the controller embodiments described above, primarily in connection with FIGS. 1 and 13.

### XVI. NANOFLUID-BASED COOLING OF WELDING EQUIPMENT

As mentioned, aspects of the present technology relate to cooling welding equipment using a relatively cold nanofluid positioned in (e.g., passing through) a compartment adjacent the equipment.

A primary welding-equipment component for cooling, or chilling, is a welding head. In operation of a fusion- or laser-type welding apparatus, for instance, a laser head heats while emitting laser rays for forming the weld. Without cooling, performance of the head could degrade or the head could be damaged.

In one embodiment, a wall of the compartment contacts a portion—e.g., welding head—of the welding equipment being cooled. In a contemplated implementation, the compartment is configured and arranged—e.g., connected to the welding equipment—so that the cooling fluid contacts directly the portion—e.g., welding head—of the welding equipment being cooled.

The cooling component can be, include, or be a part of what can be referred to as a heat exchanger. For smaller-scale implementations, the cooling apparatus can be referred to as a micro-heat exchanger.

### XVII. NANOFLUIDS, EXAMPLE ENGINEERING AND TYPES

Nanofluids are engineered colloidal suspensions of nanometer-sized particles in a base fluid. The nanoparticles are typically metals, oxides, carbides, or carbon nanotubes. Example base fluids include water, ethylene glycol, and oil.

Nanofluids are made to have unique properties, such as super-cooling or super-heating characteristics. A nanofluid could be engineered to have a thermal conductivity and convective-heat-transfer coefficient that are greatly enhanced over that of the base fluid, alone, for example. Engineering the fluid can include, for instance, magnetically polarizing the nanoparticles to obtain the desired qualities.

While the nanofluid can include other nanoparticles without departing from the scope of the present disclosure, in various embodiments, the nanofluid includes one or a combination of silicon nanoparticles and metal-based nanoparticles.

The nanofluid is for some implementations, surface functionalized. Surface functionalization of nanoparticles involves introducing functional groups (e.g., OH, COOH, polymer chains, etc.) to a surface of a nanoparticle. One characteristic of surface-functionalized nanofluids is increased particle dispersion in the nanofluid. Increased particle dispersion can be beneficial because it leads to increased thermal capacity, increased dispersion of thermal energy, and increased longevity of nanoparticle suspension. Another result is that conductive nanoparticles can be isolated using surface functionalization, which can beneficially result in or be related to increased control over particle density in the fluid.

As also mentioned, while nanofluids are discussed herein as the primary fluid for use in the present systems, other fluids able to perform as desired can be used. The fluids can include, e.g., microfluids, having micro-sized particles in a base fluid.

### XVIII. SELECT BENEFITS OF THE PRESENT TECHNOLOGY

Many of the benefits and advantages of the present technology are described herein above. The present section restates some of those and may references some others. The benefits are provided by way of example, and are not exhaustive of the benefits of the present technology.

The thermal-management systems of the present technology, in various embodiments, allow efficient exchange of thermal energy during fusion welding or other joining methods.

The thermal-management systems of the present technology, in various embodiments, allow active, efficient, and in some embodiments selective pre-heating, using nanofluid, of one or both workpieces being joined by welding. The thermal-management systems of the present technology, in various embodiments, allow active, efficient, and in some embodiments selective preheating a joining/welding interface or joint formed or being formed between the workpieces. The pre-heating reduces the amount of energy needed from the welding energy applicator (e.g., ultrasonic horn or laser head). The pre-heating also expedites the welding step.

The thermal-management systems of the present technology, in various embodiments, allows active, efficient, effective, and select cooling, or chilling, using nanofluid, of one or both workpieces. The thermal-management systems of the present technology, in various embodiments, allows active, efficient, effective, and select cooling, or chilling, using nanofluid, of a joining/welding interface or joint formed or being formed between the workpieces, after the welding. Benefits of such cooling (e.g., rapid cooling or chilling) after welding can include, in implementations in which both workpieces being joined includes metal—e.g., different metals—limiting, if not completely avoiding, formation of intermetallic compound formation. The technology can thus be an enabler of, or facilitate, joining dissimilar metals by inhibiting intermetallic growth.

Another benefit of various embodiments is an ability to heat and cool the same workpieces, selectively, as deemed appropriate, during the same welding process. The functions can include, e.g., pre-heating the workpiece(s) using the nanofluids before and during welding, and then cooling the workpiece(s) thereafter using another batch of nanofluid.

For embodiments by which one or both workpieces are pre-heated, benefits include shortening the weld cycle time, and facilitating formation of a high quality and robust weld.

Benefits of chilling a welding equipment component, such as a laser-welding head, include effectively reducing the footprint of the chiller. This is because of higher heat exchange rates.

### IX. CONCLUSION

Various embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

The above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed:

1. A thermal-management system, for use in controlling temperature of at least a first workpiece of multiple workpieces being joined by welding, comprising:
a thermal sleeve sized and shaped to at least partially surround the first workpiece during operation of the thermal-management system;
wherein the thermal sleeve comprises a fluid compartment configured to hold heat-transfer fluid for use in heating or cooling the first workpiece during operation of the thermal-management system.

2. The thermal-management system of claim 1 wherein the thermal sleeve comprises a welding-access port sized, shaped, and arranged on the thermal sleeve to allow welding of the workpieces through the welding-access port while the sleeve at least partially surrounds the first workpiece.

3. The thermal-management system of claim 1 wherein the thermal sleeve is sized and shaped to at least partially surround a second workpiece and the first workpiece, for controlling temperature of the first and the second workpiece during operation of the thermal-management system.

4. The thermal-management system of claim 3 wherein the thermal sleeve comprises multiple welding-access ports sized, shaped, and arranged on the thermal sleeve to allow welding of the workpieces through the welding-access ports while the sleeve at least partially surrounds the first workpiece and the second workpiece.

5. The thermal-management system of claim 3 wherein the thermal sleeve is sized and shaped to fit snugly around the first and second workpieces.

6. The thermal-management system of claim 1 wherein the thermal sleeve comprises a fluid inlet and a fluid outlet in the fluid compartment during operation of the thermal-management system, wherein:
the fluid inlet is positioned at a first point of the fluid compartment for receiving fresh heat-transfer fluid during operation of the thermal-management system; and
the fluid outlet is positioned at a second point of the fluid compartment for releasing from the fluid compartment used heat-transfer fluid during operation of the thermal-management system.

7. The thermal-management system of claim 1 further comprising the heat-transfer fluid, wherein the heat-transfer fluid is surface functionalized, yielding a surface-functionalized heat-transfer fluid, to, in operation of the system, cool or heat the first workpiece in a predetermined manner.

8. The thermal-management system of claim 7 wherein the heat-transfer fluid includes nanoparticles and the surface-functionalized heat-transfer fluid is surface functionalized by addition of a functional group at a surface of the nanoparticles.

9. The thermal-management system of claim 7 wherein nanoparticles of the surface-functionalized heat-transfer fluid have more particle dispersion, or are more isolated, than nanoparticles of the heat-transfer fluid if not surface functionalized.

10. The thermal-management system of claim 7 further comprising the heat-transfer fluid, wherein the heat-transfer fluid comprises silicon (Si) nanoparticles with a base fluid.

11. The thermal-management system of claim 1 further comprising a fluid modification device in fluid communication with the fluid compartment, the fluid modification device being configured to, in operation of the thermal-management system, modify at least one characteristic associated with the heat-transfer fluid in a predetermined manner to cool or heat the first workpiece more effectively than the heat-transfer fluid would if not modified.

12. The thermal-management system of claim 11 further comprising a computerized controller configured for wired or wireless communication with the fluid modification device, and to send a signal to the fluid modification device causing the fluid modification device to modify said characteristic.

13. The thermal-management system of claim 11 wherein said characteristic comprises at least one of:
a magnetic polarity of the heat-transfer fluid;
a type of nanoparticles in the heat-transfer fluid;
a concentration of nanoparticles in the heat-transfer fluid;
a ratio of base fluid-to-nanoparticles of the heat-transfer fluid;
temperature of the heat-transfer fluid; and
flow rate of the heat-transfer fluid through the fluid compartment.

14. The thermal-management system of claim 1 wherein:
the fluid compartment is a first fluid compartment; and
the thermal sleeve comprises a second fluid compartment unconnected fluidly with the first fluid compartment.

15. The thermal-management system of claim 14 wherein:
the thermal sleeve comprises a welding-access port sized, shaped, and arranged on the thermal sleeve to allow welding of the workpieces through the welding-access port while the sleeve at least partially surrounds the first workpiece; and
the first fluid compartment defines or at least partially surrounds the welding-access port.

16. The thermal-management system of claim 1 further comprising:
a first fluid inlet for the thermal sleeve;
a first fluid outlet at the thermal sleeve;
a second fluid inlet for the compartment;
a second fluid outlet at the compartment; and
elongate channels connecting the first fluid inlet and the first fluid outlet to the second fluid inlet and the second fluid outlet, respectively, for delivering the heat-transfer fluid to and from the compartment in operation of the thermal-management system.

17. A thermal-management system, for use in controlling temperature of at least a first workpiece of multiple workpieces being joint, comprising:
a first fixture portion comprising an elongate channel;
wherein the first fixture portion is sized and shaped to be positioned adjacent the first workpiece during an operation of welding the first workpiece to a second workpiece of the multiple workpieces; and
wherein the elongate channel is configured to channel heat-transfer fluid for cooling or heating the first workpiece during operation of the thermal-management system.

18. The thermal-management system of claim 17 wherein:
the elongate channel is a first elongate channel;
the thermal-management system further comprises a second fixture portion comprising a second elongate channel unconnected fluidly with the first elongate channel;
the second fixture portion is sized and shaped to be positioned adjacent the second workpiece during the welding operation; and
the second elongate channel is configured to channel the heat-transfer fluid for cooling or heating the second workpiece during operation of the thermal-management system.

19. The thermal-management system of claim 17 wherein the first fixture portion comprises a trough or gap for use in the welding process.

20. A thermal-management system, for use in controlling temperature of at least a first workpiece of multiple workpieces being joint, comprising:
a heat-transfer fluid bath body configured to hold heat-transfer fluid during operation of the thermal-management system;
a fluid inlet and a fluid outlet for use in refreshing the heat-transfer fluid in the bath body during operation of the thermal-management system, wherein:
the fluid inlet is positioned at a first point of the heat-transfer fluid bath body for receiving fresh heat-transfer fluid during operation of the thermal-management system; and
the fluid outlet is positioned at a second point of the heat-transfer fluid bath body for releasing from the bath body used heat-transfer fluid during operation of the thermal-management system.
